(19) United States
(12) Patent Application Publication
(10) Pub. No.: US 2003/0203140 A1
(43) Pub. Date: Oct. 30, 2003

(54) Stain-resistant plastic articles and methods of making same

(76) Inventors: Elena Sapatova, Copley, OH (US); Rob Peterson, Medina, OH (US); John Travers, North Royalton, OH (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/131,649

(22) Filed: Apr. 24, 2002

(51) Int. Cl. B32B 1/02; B29C 45/00; B29C 41/04; B29C 47/06

(52) U.S. Cl. 428/35.7; 264/171.13; 264/310; 264/328.1; 264/331.18; 156/245; 156/244.11; 156/244.24; 156/244.25

(57) ABSTRACT

An economical, three-dimensional reusable plastic article that is resistant to damage and stress caused by a variety of factors is disclosed. The plastic article comprises a polycarbonate/polyester plastic blend, and optionally further comprises a plastic insert. The polycarbonate/polyester blend may be fused directly to the optional plastic insert. Alternatively, the polycarbonate/polyester blend may be tied to the optional plastic insert through the use of an adhesive layer and/or a tie layer.

### BACKGROUND

1. Technical Field

Articles comprising resinous plastic materials, and methods of making the same are disclosed. More specifically, plastic articles that are resistant to damage and stress caused by a variety of factors are disclosed.

2. Description of the Related Art

A large variety of plastic articles are commonly fabricated from “commodity” resins such as polyethylene, polypropylene, and polystyrene. Such plastic resins have successfully been applied to various home products, including food containers, storage containers, garbage cans, insulated containers, and baby products. These products are popular with consumers because they are economical, lightweight, and useful in many different environments.

One problem associated with such commercially available plastic products relates to their propensity to be damaged by heat and/or chemicals. For example, food containers made of polyethylene, polypropylene, and/or other “commodity” resins frequently stain when used to store and reheat foodstuffs.

With respect to food containers that have been used to store tomato-based sauces, staining is a well-known problem. Tomato-based sauces contain lycopene, a carotenoid pigment responsible for the red color of tomatoes. Under certain conditions of use, lycopene can be deposited on the interior food-contacting container surface, causing the food container to take on an unsightly appearance. Other foodstuffs also contain pigments that are capable of staining commercially available plastic products.

Alternatively, pigments such as lycopene may migrate/diffuse into the wall of the plastic container, thereby also causing the food storage container to retain an unattractive reddish-orange stain. The elevated temperatures produced during microwave reheating exacerbate such pigment-based staining. While such staining occurs at a faster rate at elevated temperatures, e.g., temperatures greater than 65° C., such pigment-based staining can also occur at refrigeration temperatures, albeit at a slower rate.

Food storage containers made of polyethylene, polypropylene, and other “commodity” resins are especially susceptible to staining when vegetable and/or animal-based oils are present in the foodstuff that is being stored and/or heated. Such increased staining may occur because the relatively non-polar nature of these commodity resin materials allows greater amounts of diffusion of non-polar substances (such as oils), which may contain dispersed pigments (e.g., lycopene), into the resin. This diffusion occurs at a slow rate under refrigeration conditions. However, when used in a microwave oven, products made with commodity resins are commonly subjected to temperatures in excess of their heat distortion temperatures. At such increased temperatures, polymer chain mobility is increased, resulting in increased rates of diffusion, and consequently, greater amounts of staining.

Foodstuffs containing sugars and/or oils present special staining difficulties for food storage containers, especially when the foodstuffs are heated in the containers. For example, sugars frequently caramelize at the point where the meniscus contacts the food container surface when a foodstuff (e.g., tomato-based sauce) is heated in microwave ovens. Caramelized sugars absorb great amounts of microwave radiation, i.e., they are less transparent to microwave radiation, when compared with the foodstuff itself (which can also lose heat through evaporation). Accordingly, caramelized sugars may be heated to temperatures up to about 200° C. Such local “superheating” at the inner surface of the container can stain, melt, scar, and/or burn the inner surface of the container. This phenomenon is sometimes referred to as “pitting.”

Chemical staining caused by tomato-based foods or other food products, as well as damage caused by local superheating, is undesirable to consumers because these containers, which are intended to be reused repeatedly, become unsightly. Accordingly, efforts have been made to reduce or eliminate the staining that frequently occurs in reusable plastic food storage containers.

The use of food storage containers fabricated from “engineering” resins made up of more rigid polymers can limit the staining phenomena described above. Engineering plastics are characterized by better heat resistance, higher impact strength, high stiffness, and/or many other “improved” properties. Some engineering resins, because of their high rigidity and decreased chain mobility, have a substantially reduced rate of diffusion when compared with commodity resins. Therefore, pigments such as lycopene do not migrate into such an engineering resin to the extent observed in a product made from commodity resin.

However, engineering resins can be very expensive. Furthermore, because of more limiting processing requirements, it is expensive to manufacture containers from engineering resins such as polycarbonate. For example, multi-cavitation injection molding of polycarbonate articles manufactured from typical low melt flow polycarbonate materials has proven to be difficult because the ratio of flow distance to wall stock is too high to adequately fill multi-cavitation molds.

The phenomenon referred to as environmental stress cracking (“ESC”) represents the susceptibility of a thermoplastic part to crack or craze formation under the influence of certain chemicals, aging, weather, and/or stress. It is not desirable to use higher melt flow polycarbonate materials (which would allow for the filling of multi-cavitation molds) in the manufacture of plastic articles because of their vulnerability to environmental stress cracking and their inferior stain-resistant properties.

Consequently, reusable containers made from engineering resins are not popular with the general consumer because they are either substantially more expensive than reusable plastic containers made from inexpensive commodity resins and/or do not exhibit satisfactory environmental stress cracking and stain resistance.

One attempt at providing a reusable, stain-resistant food storage container is disclosed in International Publication No. WO 00/38917 (Jul. 6, 2000). This publication discloses a two-layer structure including an inner, stain-resistant layer and an outer, heat-durable layer. The inner, stain-resistant layer of polyetherimide, polyethersulphone, or polyphenylsulphide is bonded to an outer, heat-durable layer of liquid crystal polymer, aromatic polyketone, polyarylate, polyphthalamide or poly(cyclohexylene dimethylene terephthalate).

An attempt at providing reusable, stain-resistant microwave cookware is disclosed in U.S. Pat. No. 4,772,653 (Sep. 20, 1988). This patent discloses cookware fabricated from a blend of at least two materials, which is both stain-resistant and heat-resistant. The blend includes an interpolymer formed from unsaturated dicarboxylic acid compounds and vinyl monomers, and at least one thermoformable polymer such as polycarbonate, poly(aryl ether) resins, polyarylates and polyetherimides.

While certain food storage and/or cookware containers that provide stain-resistance are known, no formulation or structure has been developed which provides an inexpensive reusable container, cookware article or home consumer product that can be manufactured at a cost that is competitive with reusable products made from commodity resins, that is acceptable to the home consumer, and that exhibits adequate environmental stress cracking resistance.

### SUMMARY OF THE DISCLOSURE

Stain-resistant plastic structures that are resistant to damage and stress caused by a variety of factors, and methods of making the same are disclosed.

More specifically, reusable, three-dimensional articles comprising a stain resistant material, wherein the stain resistant material has a melt flow greater than or equal to about 40 grams per 10 minutes at 300° C. and 1.2 kg, and a heat distortion temperature greater than or equal to about 80° C. are disclosed.

Three-dimensional plastic structures comprising a polycarbonate/polyester blend, which optionally further have a plastic insert are also disclosed. The polycarbonate/polyester blend may be fused directly to the optional plastic insert. Alternatively, the polycarbonate/polyester blend may be tied to the optional plastic insert through the use of adhesive and/or tie layers.

The disclosed products may be produced through a variety of methods including, without limitation, injection molding, injection stretch blow molding, thermoforming, extrusion blow molding, insert molding, co-injection molding, and rotational molding.

Other advantages and refinements of the disclosed products and manufacturing methods will be apparent to those skilled in the art from a review of the following detailed description.

### DETAILED DESCRIPTION OF THE PRESENTLY PREFERRED EMBODIMENTS

Reusable, three-dimensional plastic articles are disclosed that are both economical to manufacture and capable of resisting damage and stress caused by a variety of factors. Therefore, the disclosed products may be marketed to consumers who are accustomed to low priced plastic products manufactured from commodity resins, while simultaneously providing the damage resistance benefits of engineering resins. Accordingly, the disclosed products provide the protective benefits of engineering resins at a cost that is comparable to products made solely of commodity resins.

Articles are manufactured from a polycarbonate/polyester plastic blend. Typically, the weight ratio of the polycarbonate material to the polyester material in the disclosed blend is between about 5.0 and about 0.5.

The blend typically comprises about 40 wt. % to about 80 wt. % polycarbonate. More preferably, the blend comprises about 50 wt. % to about 75 wt. % polycarbonate. Most preferably, the blend comprises about 55 wt. % to about 70 wt. % polycarbonate.

Further, the blend typically comprises about 20 wt. % to about 60 wt. % polyester. More preferably, the blend comprises about 25 wt. % to about 50 wt. % polyester. Most preferably, the blend comprises about 30 wt. % to about 45 wt. % polyester.

The blend can be produced by actively blending the component materials on line, in accordance with the weight percentages disclosed above. Alternatively, blends can be purchased directly from a manufacturer. Acceptable alloys or blends include commercial products such as EastAlloy® polymers (Eastman Chemical Company, Kingsport, Tenn.), and Xylex™ resins (General Electric Company, GE Plastics, Pittsfield, Mass.), which have been modified (e.g., the polycarbonate content has been increased) to have heat distortion temperatures greater than or equal to about 80° C., and suitable melt flow characteristics to allow the article to be molded (e.g., the blends should possess a melt flow value of greater than or equal to about 40 grams per 10 minutes at 300° C. and 1.2 kg). The adjustments to the physical parameters of the resin vary depending on the physical dimensions/specifications of the article to be molded and the molding apparatus which is used to manufacture the same, and can be ascertained without undue experimentation by one having ordinary skill in the art.

Alloys are combinations of two or more plastics which are mechanically blended; they do not depend on chemical bonds but often require special compatibilizers. Plastic alloys are usually designed to retain the best properties of each constituent. The terms alloy and blend are often used interchangeably, but generally an alloy is a subclass of plastic blends. Most high performance blends are alloys. As set forth above, the terms alloy and blend are used interchangeably herein.

Several manufacturing advantages are realized from the better flow characteristics of a plastic blend in accordance with this disclosure. For example, the wall stock of a container made with the plastic blend of this disclosure may be as much as 20% thinner than the wall stock of a container made solely of polycarbonate material. This reduction in the amount of wall stock needed to manufacture a container allows for an appreciable material costs-savings.

A reduction in wall stock thickness also has an effect in reducing cooling time. Accordingly, the reduction in wall stock results in significant cycle costs savings, and thus better productivity, because cooling time is typically the longest part of the molding cycle. A lower processing temperature also reduces energy consumption.

Additionally, the disclosed blends can be processed with lower tonnage machines, i.e., for example, a lower pressure is required to fill the mold when compared with 100 wt. % polycarbonate materials typically used for the manufacture of reusable, three-dimensional articles. Consequently, plastic articles constructed from the disclosed blends can be manufactured with less capital expenditure and energy requirements.

Examples of the polycarbonate material for use in the plastic blend include compounds having the following chemical formula:

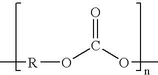

Additionally, U.S. Pat. No. 4,880,855, discloses numerous dihydric phenols that may be reacted with phosgene (or other carbonate precursors) to provide polycarbonate materials for use in the disclosed blends. The dihydric phenols which may be employed to provide such carbonate polymers are mononuclear or polynuclear aromatic compounds, containing as functional groups two hydroxy radicals, each of which is attached directly to a carbon atom of an aromatic nucleus. Typical dihydric phenols are: 2,2-bis(4-hydroxyphenyl)propane; hydroquinone; resorcinol; 2,2-bis-(4-hydroxyphenyl)pentane; 2,4′-dihydroxydiphenylmethane; bis-(2-hydroxyphenyl)methane; bis-(4-hydroxyphenyl)methane; bis-(4-hydroxy-5-nitrophenyl)methane; 1,1-bis,(4-hydroxyphenyl)ethane; 3,3-bis(4-hydroxyphenyl)pentane; 2,2-dihydroxydiphenyl; 2,6-dihydroxynaphthalene; bis-(4-hydroxydiphenyl)sulfone; bis-(3,5-diethyl-4-hydroxyphenyl)sulfone; 2,2-bis-(3,5 -dimethyl-4-hydroxyphenyl)propane; 2,4′-dihydroxydiphenyl sulfone; 5′-chloro-2,4′-dihydroxydiphenyl sulfone; bis-(4-hydroxyphenyl)diphenyl sulfone; 4,4′-dihydroxydiphenyl ether; 4,4′-dihydroxy-3,3′-dichlorodiphenyl ether; 4,4′-dihydroxy-2,5-dihydroxydiphenyl ether; and the like. Other dihydric phenols which are also suitable for use in the preparation of the above polycarbonates are disclosed in U.S. Pat. Nos. 2,999,835; 3,028,365; 3,334,154; and 4,131,575.

These polycarbonates can be manufactured by known processes, such as, for example and as mentioned above, by reacting a dihydric phenol with a carbonate precursor, such as phosgene, in accordance with methods set forth in the above-cited patents as well as U.S. Pat. Nos. 4,018,750 and 4,123,436, or by transesterification processes such as are disclosed in U.S. Pat. No. 3,153,008, as well as other processes known to those skilled in the art.

It is possible to employ two or more different dihydric phenols or a copolymer of a dihydric phenol with a glycol or with a hydroxy or acid terminated polyester or with a dibasic acid in the event a carbonate copolymer or interpolymer rather than a homopolymer is desired for use in the preparation of the polycarbonate mixtures. Branched polycarbonates are also useful, such as are described in U.S. Pat. No. 4,001,184, also there can be utilized blends of a linear polycarbonate and a branched polycarbonate. Moreover, blends of any of the above materials may be employed to provide the polycarbonate materials suitable for use in the disclosed blends. Preferably, polycarbonate materials for use in the plastic blends are derived from bis-phenols. More preferably, polycarbonates derived from bis-phenol A (2,2-bis(4-hydroxyphenyl)propane), bis-phenol TMC (trimethylenecyclohexane bisphenol), and mixtures thereof are used in the disclosed plastic blends. Most preferably, polycarbonates derived from bis-phenol A are used.

As used herein, the term polyester excludes polycarbonate materials, i.e., molecules having a carbonate linkage are not contemplated for use as polyesters in the disclosed blends. Examples of the polyester material for use in the disclosed plastic blends include compounds having the following chemical formula:

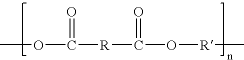

Suitable polyesters may be derived from an aliphatic, aliphatic ether, or cycloaliphatic diol, containing from 2 to about 10 carbon atoms and one or more aromatic or cycloaliphatic dicarboxylic acids. One preferred polyester is derived from an aliphatic diol and an aromatic dicarboxylic acid. Specific among these are the poly(alkylene terephthalates, i.e., poly(ethylene terephthalate) and poly(butylene terephthalate). Polyesters derived from dimethyl terephthalate or terephthalic acid are preferred.

A variation of this first polyester replaces a portion of the aliphatic diol and aromatic dicarboxylic acid with additional amounts of diols and/or diacids in amounts of from 0.5 to 50 weight percent based on the total composition. The additional diacids can be aliphatic or cycloaliphatic with the number of carbon atoms ranging from 2 to 20. Likewise, additional diols can be cycloaliphatic or aliphatic with the number of carbon atoms covering the same range. Polyalkylene ether glycols can also be used where the alkylene portion has from 2 to 10 carbon atoms and the entire glycol portion varies in molecular weight from 100 to 10,000. All such polyesters can be made following the teachings of, for example, U.S. Pat. Nos. 2,465,319 and 3,047,539.

A second preferred polyester is derived from a cycloaliphatic diol and an aromatic or cycloaliphatic dicarboxylic acid. These polyesters may be prepared, for example, by condensing either the cis- or transisomer (or mixtures thereof) of, for example, 1,4-cyclohexanedimethanol with a dicarboxylic acid such as isophthalic and/or terephthalic acid. Examples of additional aromatic dicarboxylic acids are 1,2-di(p-carboxyphenyl)ethane, 4,4′-dicarboxydiphenyl ether, etc., and mixtures of these. Dicarboxylic acids containing fused rings can also be present, such as in 1,4- or 1,5-naphthalenedicarboxylic acids. Also contemplated are cycloaliphatic diacids, such as cyclohexane dicarboxylic acid. However, the preferred dicarboxylic acids are terephthalic acid or a mixture of terephthalic and isophthalic acids.

Still a third polyester is a copolyester derived from a cyclohexane dimethanol, an alkylene glycol and an aromatic dicarboxylic acid. These copolyesters are prepared by condensing either the cis- or trans-isomer (or mixtures thereof) of, for example, 1,4-cyclohexanedimethanol and an alkylene glycol with an aromatic or cycloaliphatic dicarboxylic acid. A preferred such polyester may be derived from the reaction of either the cis- or trans-isomer (or mixtures thereof) of 1,4-cyclohexanedimethanol and ethylene glycol with terephthalic acid in a molar ratio of, for example, 80:20:100.

More specifically, polyesters for use in the blend include polyethylene terephthalate (PET), polydihydroxymethylcyclohexyl terephthalate, polycyclohexylenedimethylene terephthalate, glycol (PCTG), polycyclohexylenedimethylene terephthalate, acid (PCTA), unsaturated polyesters, aromatic polyesters, and mixtures thereof.

Copolyester materials derived from dimethyl terephthalate or terephthalic acid are preferred for use as polyester materials in the blends disclosed herein. Copolyesters such as PCTA and PCTG are particularly preferred for use as polyester materials in the disclosed blends. Most preferably, the polyester material is PCTG.

It is desirable for the blends and the plastic articles made from the blends disclosed herein to be optically transparent for several reasons. For example, plastic articles that are optically transparent are more aesthetically pleasing to the consumer. It is also easier for the consumer to monitor the contents of an optically transparent food container. Optical transparency can be measured by ASTM Test Method D1003-00. Preferably, plastic articles made from the blends disclosed herein have transmittance values greater than or equal to about 80% at 0.100 inches. More preferably, plastic articles made from the blends disclosed herein have transmittance values greater than or equal to about 85% at 0.100 inches.

The disclosed blends have shown excellent chemical resistance to foodstuffs containing pigments. Accordingly, articles made from such blends successfully resist chemical staining. As used herein, the term chemical staining includes both the discoloration caused by the migration and/or deposition of pigments, and the damage caused by the local superheating phenomena described in the background section, supra.

When used to manufacture reheatable plastic articles, the disclosed blends preferably possess heat distortion temperatures greater than or equal to about 80° C. More preferably, the disclosed blends which are used for reheatable plastic articles possess heat distortion temperatures greater than or equal to about 100° C. Most preferably, the disclosed blends which are used for reheatable plastic articles possess heat distortion temperatures greater than or equal to about 120° C. As used herein, heat distortion temperature, also referred to as deflection temperature under load (DTUL), means the temperature at which materials deflect a given distance at a given load. Heat distortion temperatures can be measured by known methods, including ASTM Test Method D648-01. Heat distortion temperatures as reported herein are measured at 66 psi, unannealed.

Articles comprising a disclosed plastic blend preferably exhibit notched izod impact resistance values greater than or equal to about 4 foot-lbs/inch sample thickness at room temperature. Even more preferably, articles comprising a disclosed plastic blend preferably exhibit notched izod impact resistance values greater than or equal to about 14 foot-lbs/inch sample thickness at room temperature. Impact resistance can be measured by known methods, including ASTM Test Method D256-00 Test Method A.

Finally, the disclosed blends also preferably have melt flow values that are advantageous for manufacturability. Melt flow or melt index values indicate the amount of plastic that can extruded in ten minutes through an opening under a prescribed load. Typically, the disclosed blends have melt flow values of greater than or equal to about 40 grams per 10 minutes at 300° C. and 1.2 kg. More preferably, the disclosed blends have melt flow values of greater than or equal to about 45 grams per 10 minutes at 300° C. and 1.2 kg. Such melt flow values allow for the implementation of multi-cavitation tools, and a commensurate increase in productivity may be observed. Melt flow values can be measured by known methods, including ASTM Test Method D1238.

In one embodiment, the reusable, three-dimensional plastic article comprises a food storage container. As previously discussed, food containers comprising a plastic blend in accordance with this disclosure successfully resist chemical staining, and thus are more pleasing and useful to the consumer.

In another embodiment, the reusable, three-dimensional plastic article comprises a cutting-board. Cutting boards manufactured from a blend according to this disclosure also demonstrate superior stain resistant properties when compared with cutting boards manufactured from conventional materials. Additionally, cutting boards comprising a plastic blend in accordance with this disclosure do not warp as much as cutting boards comprising conventional materials.

In yet another embodiment, the reusable, three-dimensional plastic article comprises a baby high chair tray. In other embodiments, the reusable, three-dimensional plastic article may comprise other plastic articles that are used to hold and/or contain hot foodstuffs.

Plastic articles can be manufactured using conventional manufacturing methods that are well known in the art. For example, injection molding, stretch blow molding, thermoforming, extrusion blow molding, insert molding, co-injection molding, rotational molding, and other methods may successfully be applied to produce plastic articles.

A plastic article manufactured in accordance with this disclosure may have an insert in contact with the inner surface of the polycarbonate/polyester plastic blend. According to one embodiment, the insert is in direct contact with the plastic blend, i.e., the insert is directly fused to the plastic blend. In this embodiment, the insert is chemically bonded to the plastic blend, for example, by virtue of the two materials melting together.

Typically, the insert material is selected for its chemical resistance and its compatibility with the disclosed plastic blend. The insert is typically manufactured from polycarbonate materials. Polycarbonates derived from bis-phenols (e.g., polycarbonates derived from bis-phenol A and bis-phenol TMC) and mixtures thereof are especially preferred. Additionally, as set forth above, U.S. Pat. No. 4,880,855 discloses numerous dihydric phenols that may be reacted with phosgene to provide polycarbonate materials for use as an insert in conjunction with the disclosed blends.

In an alternative embodiment, the insert may be tied to the plastic blend through the use of an adhesive layer and/or a tie layer. According to this embodiment, a three-layer plastic structure is produced. Adhesive and tie layers must adhere to both the blend of this disclosure and the insert in order to resist delaminating during use, especially at the high temperatures encountered with microwave heating.

Tie layer resins may be modified polyolefins with functional groups such as ADMER® adhesive resins (Mitsui Chemicals America, Inc., Purchase, N.Y.), modified ethylene vinyl acetate polymers such as BYNEL® adhesive resins (DuPont Company, Wilmington, Del.), ethylene vinyl acetate copolymers and terpolymers blended with petroleum waxes and resin tacifiers such as ELVAX® EVA resins (DuPont Company, Wilmington, Del.), and ethylene methyl acrylate EMAC® copolymer resins (Eastman Chemical Company, Kingsport, Tenn.). The tie layer must be compatible with a co-extrusion process, and capable of bonding to the polycarbonate and polyester materials listed above.

Adhesive layers that may successfully be used to adhere the disclosed blend to the optional insert include epoxy-based adhesives, urethane-based adhesives, acrylic-based adhesives, and the like.

Although the foregoing text sets forth a detailed description of numerous different embodiments, it should be understood that the legal scope of this disclosure is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the following claims.

What is claimed is:

1. A reusable, three-dimensional article comprising:
a stain resistant material, wherein the stain resistant material has a melt flow greater than or equal to about 40 grams per 10 minutes at 300° C. and 1.2 kg, and a heat distortion temperature greater than or equal to about 80° C.

2. The article of claim 1, wherein the stain resistant material comprises a polycarbonate/polyester blend.

3. The article of claim 1, further comprising an insert that is in contact with the stain resistant material.

4. The article of claim 1, wherein the material is resistant to staining caused by tomato-based pigments.

5. The article of claim 1, wherein the material is resistant to staining caused by lycopene.

6. A reusable, three-dimensional article comprising:
a polycarbonate/polyester plastic blend.

7. The article of claim 6, wherein the polycarbonate is derived from one or more dihydric phenols.

8. The article of claim 6, wherein the polycarbonate is derived from one or more bisphenols.

9. The article of claim 6, wherein the polyester is selected from the group consisting of polyethylene terephthalate (PET), polydihydroxymethylcyclohexyl terephthalate, polycyclohexylenedimethylene terephthalate, glycol (PCTG), polycyclohexylenedimethylene terephthalate, acid (PCTA), unsaturated polyesters, aromatic polyesters, and mixtures thereof.

10. The article of claim 6, wherein the polyester is a copolyester.

11. The article of claim 6, wherein the polyester is selected from the group consisting of polycyclohexylenedimethylene terephthalate, glycol and polycyclohexylenedimethylene terephthalate, acid.

12. The article of claim 6, wherein the polyester is polycyclohexylenedimethylene terephthalate, glycol.

13. The article of claim 6, wherein a ratio of the polycarbonate to the polyester ranges from about 5.0 to about 0.5 by weight.

14. The article of claim 6, wherein the plastic blend includes from about 40 weight percent to about 80 weight percent polycarbonate.

15. The article of claim 6, wherein the plastic blend includes from about 20 weight percent to about 60 weight percent polyester.

16. The article of claim 6, wherein the article comprises a food storage container.

17. The article of claim 6, wherein the article comprises a cutting board.

18. The article of claim 6, further comprising a plastic insert that is in contact with the plastic blend.

19. The article of claim 18, wherein the plastic insert comprises polycarbonate.

20. The article of claim 19, wherein the polycarbonate is derived from a dihydric phenol.

21. The article of claim 18, wherein the plastic insert is directly fused to the polycarbonate/polyester plastic blend.

22. The article of claim 18, wherein the plastic insert is tied to the polycarbonate/polyester plastic blend through the use of an adhesive layer.

23. The article of claim 22, wherein the adhesive layer is selected from the group consisting of epoxy-based adhesives, urethane-based adhesives, and acrylic-based adhesives.

24. The article of claim 18, wherein the plastic insert is tied to the polycarbonate/polyester plastic blend through the use of a tie layer.

25. The article of claim 24, wherein the tie layer is selected from the group consisting of functionalized polyolefins, ethylene vinyl acetates, modified ethylene vinyl acetates, ethylene methyl acrylates, ethylene butyl acrylates, and mixtures thereof.

26. A method of manufacturing a three dimensional article comprising:
mixing polycarbonate and polyester to provide a blend;
melting the blend to produce a flowable material; and
forming a three dimensional article from the flowable material.

27. The method of claim 26, wherein the forming comprises a process selected from the group consisting of injection molding, insert molding, co-injection molding and rotational molding.

28. The method of claim 26, further comprising attaching a plastic insert to an inner surface of the three dimensional article.

29. The method of claim 28, wherein the attaching comprises adhering the insert to the inner surface of the article with an adhesive layer.

30. The method of claim 28, wherein the attaching comprises adhering the insert to the inner surface of the article with a tie layer.

31. The method of claim 28, wherein the attaching comprises co-extruding the plastic insert onto the inner surface of the three dimensional article.

32. The method of claim 28, wherein the plastic insert comprises polycarbonate.
